(19) United States
(12) Patent Application Publication
(10) Pub. No.: US 2010/0332282 A1
(43) Pub. Date: Dec. 30, 2010

(54) ORCHESTRATING THE ARRIVAL OF ATTENDEES TO A SCHEDULED EVENT

(75) Inventors: Lisa Marie Wood Bradley, Research Triangle Park, NC (US); Lin Sun, Research Triangle Park, NC (US)

Correspondence Address: IBM CORPORATION;C/O: VanCott Bagley, Cornwall & McCarthy, 36 South State Street, Suite 1900, Salt Lake City, UT, 84111, US

(73) Assignee: International Business Machines Corporation, Armonk, NY (US)

(21) Appl. No.: 12/493,405

(22) Filed: Jun. 29, 2009

(51) Int. Cl. G06Q 10/00; G01C 21/00; G06F 15/16

(52) U.S. Cl. 705/9; 701/204; 709/206; 701/210; 701/300

(57) ABSTRACT

A method of orchestrating attendee arrival to an event includes storing a record for the event with a computerized calendar system and notifying a first attendee of the scheduled event, with the computerized calendar system, of an optimal departure time for the scheduled event from a current location of the first attendee. The first attendee is notified of the optimal departure time in response to a determined status of a second attendee in traveling to the scheduled event, and the optimal departure time includes at least one of: a specified time relative to a departure of the second attendee and a specified time relative to an anticipated arrival of the second attendee.

### BACKGROUND

Meetings, appointments, and other scheduled events often play an integral role in how one allocates his or her time. For example, often a person with a busy work schedule would prefer to not spend time idly waiting for others to show up for a meeting or other scheduled event when he or she has other urgent matters to attend to. Conversely, most people also prefer not to arrive late to a scheduled event, as doing so is typically considered impolite and may cause a distraction to other attendees or delay the commencement of the event. Furthermore, it is frequently the case that participants attend a scheduled event as compensated employees. Thus, the time spent by some attendees waiting for other attendees to arrive can be an ineffective use of an organization's resources.

Nevertheless, orchestrating the simultaneous arrival of all parties to a scheduled event is easier said than done. Clock discrepancies among the parties, unexpected delays in travel time to the event, the failure of earlier engagements to end on time, and differing views regarding the importance of punctuality may, among other factors, contribute to the lack of all parties to arrive at the same time to the event. The problem is compounded by the fact that attendees of such scheduled events frequently arrive to the event location from different locations. Thus, factors that may significantly expedite or delay the travel time of some event participants to the event location may not equally affect other participants traveling to the same location.

### BRIEF SUMMARY

A method of orchestrating attendee arrival to an event includes scheduling the event with a computerized calendar system and notifying a first attendee of the scheduled event, with the computerized calendar system, of an optimal departure time for the scheduled event from a current location of the first attendee. The first attendee is notified of the optimal departure time in response to a determined status of a second attendee in traveling to the scheduled event, and the optimal departure time is calculated to enable the first attendee to arrive at a location of the scheduled event substantially concurrent to an arrival of the second attendee to the location of the scheduled event.

A computerized calendar system includes at least one processor configured to execute scheduling or calendaring software and to communicatively couple to any of a plurality of client devices. The at least one processor is configured to maintain a record of a scheduled event, the record including a time, location, and list of attendees of said scheduled event, calculate an optimal departure time for a first attendee of the scheduled event from a current location of the first attendee, and transmit a notification to a client device associated with the first attendee that includes the optimal departure time for the first attendee. The optimal departure time is calculated for the first attendee in response to a determined status of a second attendee in traveling to the scheduled event, and is calculated to enable the first attendee to arrive at the location of the scheduled event concurrent to an arrival of the second attendee to the location of the scheduled event.

A computer program product for orchestrating attendee arrivals to an event includes a computer readable storage medium having computer readable program code embodied therewith. The computer readable program code includes computer readable program code configured to maintain a record of a scheduled event, the record including a time, location, and list of attendees of the scheduled event. The computer readable program code also includes computer readable program code configured to notify a first attendee of the scheduled event of an optimal departure time for the scheduled event from a current location of the first attendee in response to a determined status of a second attendee in traveling to the scheduled event. The optimal departure time is calculated to enable the first attendee to arrive at a location of the scheduled event substantially concurrent to an arrival of the second attendee to the location of the scheduled event.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram of an illustrative timeline for notifying an attendee of when to leave for an event, according to one exemplary embodiment of principles described herein.

FIG. 2 is a diagram of an illustrative timeline for notifying multiple users when to leave for a scheduled event, according to one exemplary embodiment of principles described herein.

FIG. 3 is a diagram of an illustrative timeline for notifying multiple users when to leave for a scheduled event, according to one exemplary embodiment of principles described herein.

FIG. 4 is a diagram of an illustrative timeline for notifying multiple users when to leave for a scheduled event, according to one exemplary embodiment of principles described herein.

FIG. 5 is a diagram of an illustrative computerized calendar system, according to one exemplary embodiment of principles described herein.

FIG. 6 is a diagram of an illustrative computerized calendar system, according to one exemplary embodiment of principles described herein.

FIG. 7 is a diagram of an illustrative user interface for a computerized calendar system, according to one embodiment of principles described herein.

FIG. 8 is an illustrative flowchart diagram of an illustrative method of orchestrating attendee arrivals to a scheduled event, according to one embodiment of principles described herein.

Throughout the drawings, identical reference numbers designate similar, but not necessarily identical, elements.

### DETAILED DESCRIPTION

As discussed above, it can often be a challenge to coordinate the arrival of multiple parties to a scheduled event in an efficient manner.

The present specification discloses methods and systems for orchestrating attendee arrival to a scheduled event by notifying one or more users of an optimal departure time. The optimal departure time for some attendees is calculated in response to a determined status of one or more selected attendees in traveling to the scheduled meeting.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Throughout the specification, the term “reminder system” will refer to a computerized calendar system. The computerized calendar system may include both hardware and software necessary to accomplish required tasks. The reminder system reminds users when to leave for a meeting or scheduled event. The reminder system may be stored on any type of storage medium and may be executed on any type of processing machine. In one embodiment, the reminder system may have a means of tracking the location of a user and using that information to know when to reminder other attendees when to leave for a scheduled event.

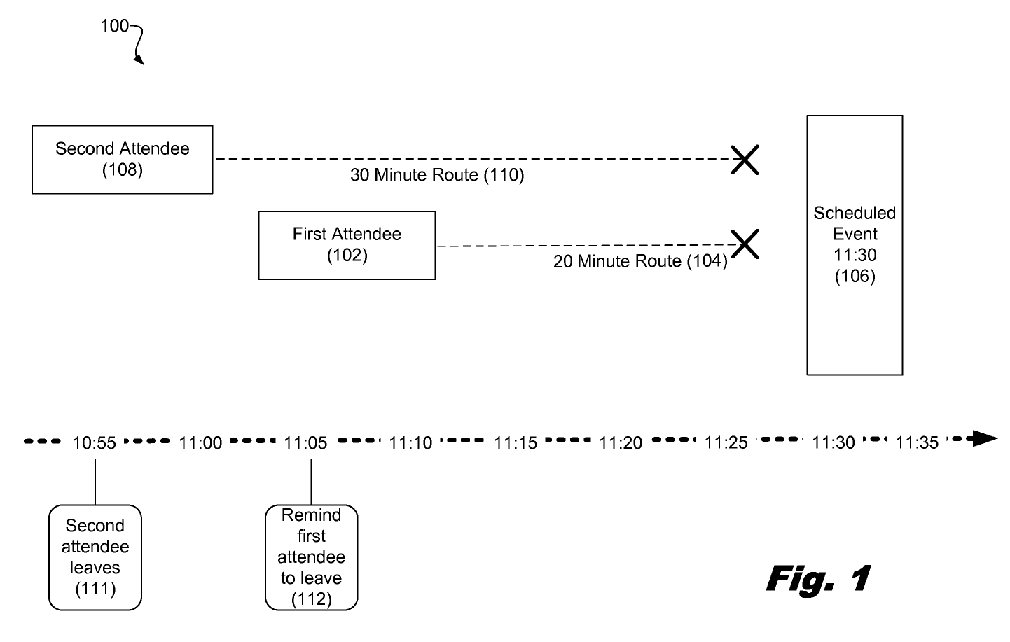

FIG. 1 is a diagram of an illustrative timeline (100) for notifying a first attendee (102) of when to leave his or her current location for a scheduled event (106). In the present example, the scheduled event (106) is set for 11:30 and both the first attendee (102) and a second attendee (108) are on a list of participants for the scheduled event (106).

In the present example, a computerized calendar system that organizes the scheduled event (106) may be aware that it will take 20 minutes for the first attendee (102) to travel from his or her current location to the location of the scheduled event (106) along a selected route (104). In certain embodiments, the computerized calendar system may determine the anticipated travel time of the first attendee by automatically plotting a logical route for the first attendee (102) to take to arrive at the scheduled event (106) and estimating the amount of time it will take for the first attendee (102) to travel to the scheduled event (106). Additionally or alternatively, the computerized calendar system may rely on input received from the first attendee (102) through a user interface to determine the amount of anticipated travel time for the first attendee (102) and/or the route to be taken by the first attendee (102) to arrive at the scheduled event (106). For example, the first attendee (102) may have access to the computerized calendar system through a personal client device communicatively coupled to the computerized calendar system.

For any of a variety of reasons, the first attendee (102) may choose to plan his or her arrival time at the scheduled event (106) based on an anticipated departure or arrival time of the second attendee (108) rather than or in addition to the scheduled commencement time of the event (106). For example, the first attendee (102) may find himself or herself particularly stretched for time on the day of the scheduled event (106) and desire to mitigate potential wasted time resulting from arriving earlier than the second attendee (108). Alternatively, the first attendee (102) may enjoy socializing with the second attendee (108) or need to discuss something with the second attendee (108) such that the first attendee (102) desires to arrive at least as early as the second attendee (108) and take advantage of any time available prior to the commencement of the scheduled event (106). In either of these embodiments, the first attendee (102) may plan to arrive to the scheduled event (106) substantially concurrent to the arrival of the second attendee (108). In still other embodiments, the first attendee (102) may wish to arrive earlier or later than the second attendee (108) and plan to do so.

Accordingly, the first attendee (102) may instruct the computerized calendar system to provide him or her with a notification of an optimal departure time based on a detected or estimated status of the second attendee (108) in arriving at the scheduled event (106) and a desired departure or arrival time specified by the first attendee (102) relative to an anticipated arrival or departure of the second attendee (108). The status of the second attendee (108) may include, but is in no way limited to, a determination of whether the second attendee (108) has already departed, a departure time of the second attendee (108), a current position of the second attendee (108), an anticipated arrival time of the second attendee (108), and an arrival time of said second attendee (108). The status of the second attendee (108) may be obtained automatically from a client device associated with the second attendee (108) (e.g., automatic updates sent from a GPS-enabled cell phone or personal digital assistant), entered manually by the second attendee (108) into the computerized calendar system (e.g., clicking a button when the second attendee (108) departs for the event), and/or estimated by the computerized calendar system from past status information (e.g., using an elapsed time since a detected departure to estimate a current position along the route to the scheduled event).

It should be understood that while the examples of FIGS. 1-4 are described in the context of the first attendee (102) receiving an optimal departure time based on the status of only the second attendee (108), the first attendee (102) may receive an optimal departure time based on the status of a plurality of other attendees for the scheduled event (106). For example, in certain embodiments, the first attendee (102) may receive an optimal departure time based on an average departure time of a plurality of attendees that have already departed for the scheduled event (106). In an alternative exemplary embodiment, the optimal departure time may be calculated for the first attendee (102) based on the detected departure of a specified number of other attendees. Any additional status indicator related to multiple other attendees may be used to determine the optimal departure time of the first attendee (102) as may suit a particular application of the principles described herein.

For example, the first attendee (102) may specify to the computerized calendar system that he or she desires to arrive at substantially the same time as the second attendee. Alternatively, the first attendee (102) may specify to the computerized calendar system that he or she desires to arrive at the location of the scheduled event (106) a specified number of minutes earlier or later than the anticipated arrival of the second attendee (108). In still other embodiments, the first attendee (102) may specify that he or she desires to depart for the scheduled event (106) a given number of minutes after the departure of the second attendee (108) or at a given number of minutes prior to the anticipated arrival of the second attendee (108) at the location of the scheduled event (106).

Once the computerized calendar system has received the desired arrival time of the first attendee (102) with respect to either the departure or the arrival of the second attendee (108), the computerized calendar system may use the status of the second attendee (108) in arriving at the location of the scheduled event (106) to calculate an optimal departure time for the first attendee (102). In certain embodiments, the calculated optimal departure time for the first attendee (102) may involve the automatic determination of a route and estimated travel time from the current location of the first attendee (102) to the location of the scheduled event (106). In other embodiments, the first attendee (102) may specify a desired route and/or an estimated travel time from his or her current location to the location of the scheduled event (106) for use in calculating the optimal departure time of the first attendee (102) and notifying the first attendee (102) of the optimal departure time.

The computerized calendar system may notify the first attendee (102) of the optimal departure time through a user interface or by transmitting a message to a client device associated with the first attendee (102). For example, the computerized calendar system may cause a reminder window to popup on a computer of the first attendee (102) or transmit a message to a mobile device associated with the first attendee (102). In certain embodiments, the notification may occur substantially at the optimal departure time. Additionally or alternatively, the notification may occur, as specified, by the first attendee (102), at a certain amount of time prior to the optimal departure time as a reminder to the first attendee (102) to leave for the scheduled event (106).

In certain embodiments, the originator of a scheduled event may set up an automated meeting invite to make sure that the attendees have to set when they are leaving for the scheduled event and by so doing, provide a status to the computerized calendar system. For example, the reminder notifications from the computerized calendar system to the attendees may be configured to include an extra button labeled “leaving now” or “leaving in XX minutes” (XX being a user configurable numeric field).

Additionally or alternatively, the number of attendees of a scheduled event may be large enough that it makes sense or is desirable to divide the attendees into different travel groups based on driving time or any other applicable factor. In such embodiments, the first attendee (102) may receive a reminder notification with an optimal departure time based on when a specified number and/or majority of his or her group departs for the scheduled event. By so doing, the departure of group members may be coordinated such that the group members arrive at the scheduled event at substantially the same time.

It may also be possible in certain embodiments for one or more attendees to use the computerized calendar system to view at any time the status and/or location of other attendees tracked by the computerized calendar system. As such, the attendees may update how their optimal departure times are calculated dynamically depending on the status of the other attendees.

In the present example, the second attendee (108) takes a 30 minute route (110) to arrive at the scheduled event (106), the first attendee (102) takes a 20 minute route (104) to arrive at the scheduled event (106), and first attendee (102) has specified to the computerized calendar system that he or she desires to arrive at the location of the scheduled event (106) substantially concurrent to the arrival of the second attendee (108). Thus, the computerized calendar system may calculate an estimated optimal departure time for the first attendee (102) based on a detected departure of the second attendee (108) for the scheduled event. Since the second attendee (108) of the present example has departed at 10:55 (111), the computerized calendar system may estimate that the second attendee (108) will arrive at the location of the scheduled event (106) at approximately 11:25. As such, the computerized calendar system may calculate an optimal departure time for the first attendee (102) of 11:05 and provide a reminder notification (112) to the first attendee (102) to leave at that time. Accordingly, the first attendee (102) may leave at 11:05 and arrive at the location of the scheduled event at approximately 11:25—substantially concurrent to the arrival of the second attendee (108).

In alternative embodiments, the optimal departure time for the first attendee (102) may be determined relative to the departure of the second attendee (108) rather than the anticipated arrival of the second attendee (108). For example, the first attendee (102) may specify to the computerized calendar system that he or she desires to be reminded to leave 10 minutes after the second attendee (108) has left for the scheduled event (106).

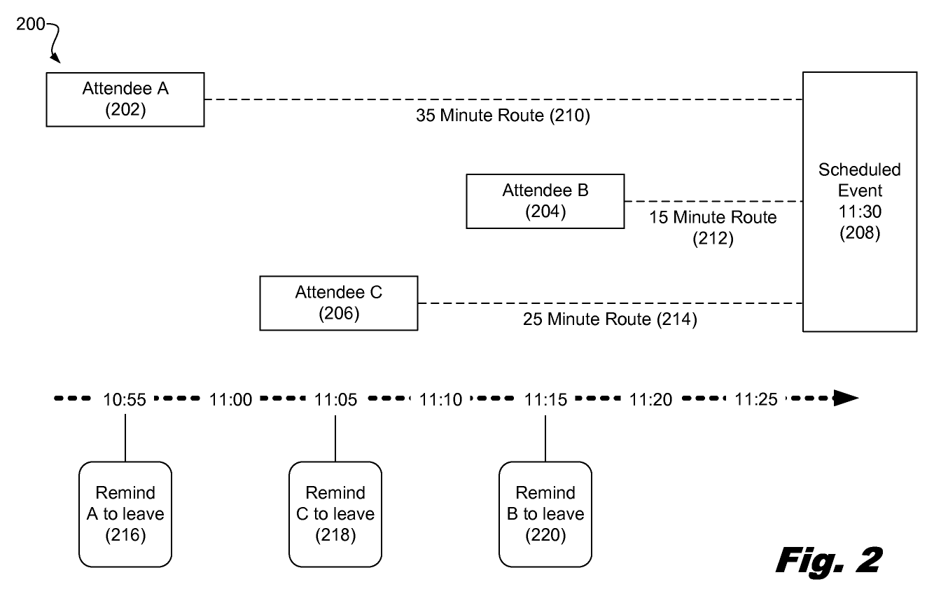

FIG. 2 is a diagram of an illustrative timeline (200) for a computerized calendar system to notify multiple users when to leave for a scheduled event. In one example, multiple attendees (202, 204, 206) all being different distances from the event location are using client devices communicatively coupled to the computerized calendar system. Attendee A (202) has a 35 minute route (210) to travel to the event location, attendee B (204) has a 15 minute route (212) to travel to the event location, and attendee C (206) has a 25 minute route (214) to travel to the event location. All attendees (202, 204, 206) wish to arrive at the meeting location at 11:30.

In the present example, attendee A (202) of the attendees (202, 204, 206) to depart for the scheduled event (208) may not necessarily specify a desired time relative to the status of either of attendees B or C (204, 206, respectively) in arriving to the scheduled event (208). Nevertheless, attendee A (202) may be given a reminder notification by the computerized calendar system of an optimal departure time for arriving to the scheduled event on time at 11:30. Alternatively, attendee A (202) may specify a different time to arrive at the location of the scheduled event, such as a few minutes prior to the commencement of the scheduled event (208). According to the present example, attendee A (202) will be given a reminder (216) to leave at 10:55, 35 minutes before the scheduled event (208).

In contrast to attendee A (202), attendees B and C (204, 206) may specify a desired arrival or departure time to the computerized calendar system relative to an arrival or departure status of attendee A (202). Continuing with the present example, attendee C (206) may specify that he or she desires to arrive at the same time as attendee A (202). As such, the computerized calendar system may use a status of attendee A (202) in arriving at the scheduled event (208) to determine an optimal departure time for attendee C (206). Assuming attendee A (202) remains on schedule, attendee C (206) will receive a reminder notification (218) to leave at 11:05, 25 minutes before the scheduled event (208). Since attendee B (204) has the shortest travel time to the location of the scheduled event (208), attendee B (204) may specify a desired arrival time at the scheduled event (208) relative to the departure or arrival of either attendee A (202) or attendee C (206). If everything goes according to schedule, at 11:15, attendee B (204) will be given a reminder (220) reminding him or her to leave 15 minutes before the scheduled event (208). All attendees (202, 204, 206) will then arrive at the event location on time.

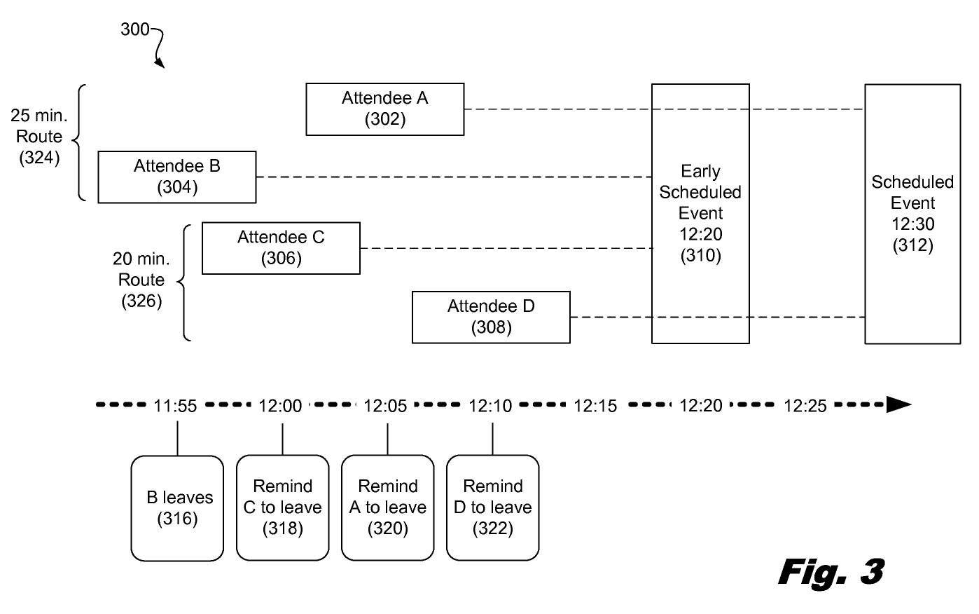

FIG. 3 is an illustrative timeline (300) for orchestrating the arrival of multiple attendees to a scheduled event. In one example, one group of attendees may wish to arrive early to the scheduled event so they can talk with one another before the rest of the attendees arrive. In the example depicted in FIG. 3, attendee B (304) and attendee C (306) wish to be at the event location 10 minutes early. Attendee A (302) and attendee D (308) wish to arrive at the event location exactly on time. Attendee A (302) and attendee B (304) both have 25 minute routes (324). Attendee C (306) and attendee D (308) both have 20 minute routes (326). Often times, it is not so much important to the attendees that an event should start at a specific time, but that all of the attendees arrive at the same time. In one embodiment, the reminder system could be set up so that the actual meeting time is dependent upon when the person who is located farthest from the earliest meeting time leaves. In the example, attendee B (304) is the farthest from the earlier meeting time (310). Whenever attendee B leaves will determine the exact event times (310, 312) and when all other attendees are given reminders to leave. According to the timeline (300), attendee B (304) leaves at 11:55 (316), making the first meeting time at 12:20 (310), 25 minutes after attendee B (304) leaves. At 12:00, attendee C (306) is given a reminder (318) to leave. At 12:05, attendee A (302) is given a reminder (320) to leave. At 12:10, attendee D (308) is given a reminder (322) to leave. Thus, attendee B (304) and attendee C (306) will arrive at the meeting location ten minutes before attendee A (302) and attendee D (308).

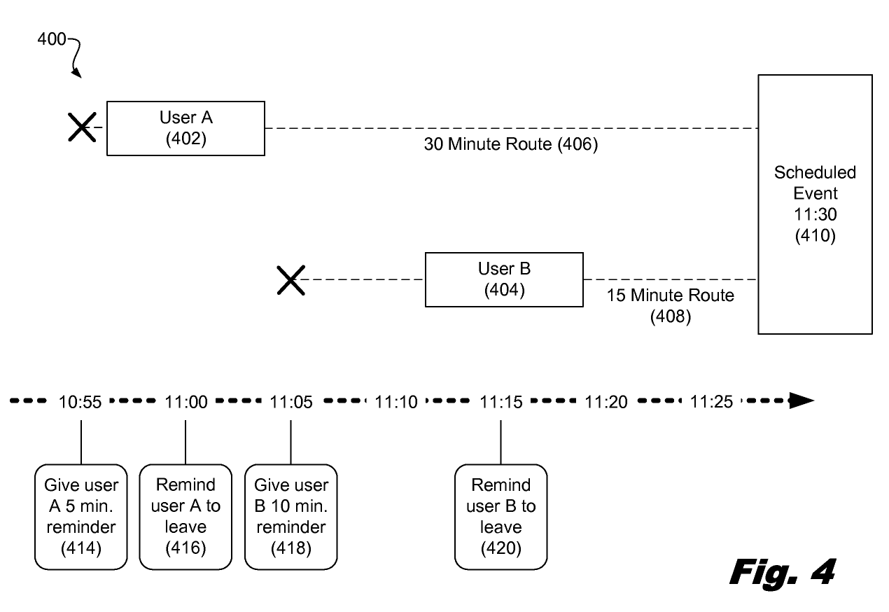

FIG. 4 is another illustrative timeline (400) for orchestrating the arrival of multiple attendees to a scheduled event. In some cases, an attendee desires to be reminded about leaving for a scheduled event a set time before the attendee needs to leave. Many attendees prefer some sort of notification five or ten minutes before it is necessary for them to leave. In the example depicted in FIG. 4, attendee A (402) has a 30 minute route (406) and prefers a five minute notification. Attendee B (404) has a 15 minute route (408) and prefers a ten minute notification. Both attendees (402, 404) wish to meet at 11:30 for a scheduled event (410). According to the timeline (400), at 10:55, attendee A (402) is given a five minute notification (414). At 11:00, attendee A (402) is reminded to leave (416). At 11:05, attendee B (404) is given a ten minute notification (418). At 11:15, attendee B (404) is reminded to leave (420). Thus, both attendees (402, 404) receiving early notification according to their preferences are able to arrive at the meeting location on time.

The previous examples present various possible aspects of a computerized calendar system. The computerized system is not limited to the previously discussed embodiments only. Any combination of principles described above could also be used or implemented.

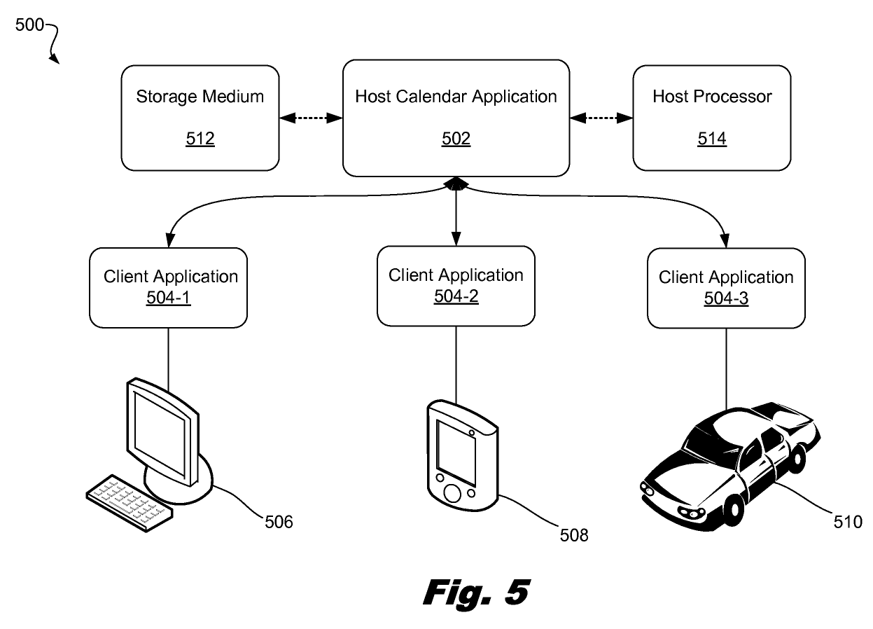

FIG. 5 is a diagram illustrating an illustrative computerized calendar system (500) for orchestrating the arrival of multiple attendees to a scheduled event consistent with the principles described above. In certain embodiments, the reminder system may include a host calendar application (502) installed on a host processor (514) and a client software application (504-1, 504-2, 504-3) installed on any number of client devices (506, 508, 510) communicatively coupled to the host processor (514). The host calendar application (502) may be stored on any type of computer readable storage medium (512) communicatively coupled to the host processor (514) such that the host software application (502) is executed by the host processor (514). The host calendar application (502) may be configured to communicate with individual instances of the client software application (504-1, 504-2, 504-3) installed on the client devices (504-1, 504-2, 504-3) through any type of communication network or means. For example, the client devices (504-1, 504-2, 504-3) may communicate with the host processor (514) through mutual connections to a local area network, a wide area network such as the Internet, and/or a cellular network.

As shown in FIG. 5, a client device (506, 508, 510) may be a computer (506). Any type of computer (506) including but not limited to a home computer, a work computer, a laptop, or a desktop may be used as may suit a particular application of the principles described herein. Another possible client device (506, 508, 510) may be a cell-phone (508) or other mobile device. Modern cell-phones often allow a variety of applications to be downloaded and used. One such application may be a client software application (504-2) for the computerized calendar system (500). Yet another example of a possible client device is a portable Global Positioning Satellite (GPS) system (510). The client software application (504-3) functionality may be integrated into the user interface of the GPS system (510). The client software application (504-1, 504-2, 504-3) installed on any type of client device may be used to facilitate a variety of features which may be implemented with the reminder system. For example, an attendee may notify the computerized calendar system host processor (514) that he or she is leaving for the location of the scheduled event by clicking a user interface button. Additionally or alternatively, the client software application (504-1, 504-2, 504-3) may also allow attendees to interact with the host processor (514) to create new scheduled events, communicate with other attendees, adjust various settings and personal parameters associated with the computerized calendar system (500), and/or other interactive features. Additionally, the notifications sent to the client device of an attendee may be handled by a calendar application already installed on the client device or included as part of the client software application (504-1, 504-2, 504-3).

In certain embodiments, the host calendar application (502) may also report to the attendees through the client software (504-1, 504-2, 504-3) the location and estimated arrival time of other attendees of a scheduled event.

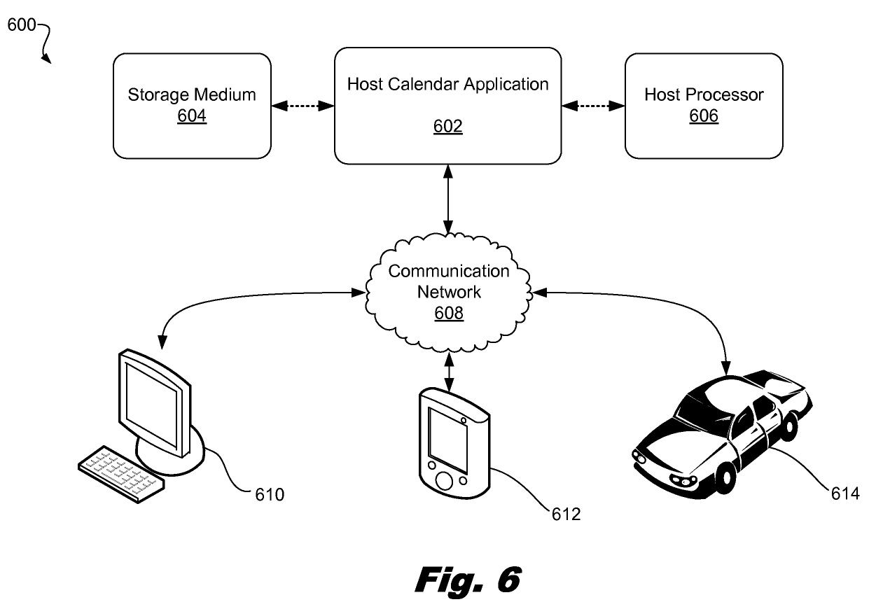

FIG. 6 is a diagram illustrating another illustrative computerized calendar system for orchestrating the arrival of multiple attendees to a scheduled event, consistent with the principles described above. In the present embodiment, instead of requiring separate client software to be individually installed on attendee client devices, the computerized calendar system (600) may be based on a web application or other web service. In such embodiments, the client devices (610, 612, 614) may communicate directly with a host processor (606) configured to execute the host calendar application (602) through a web browser or other web service interface. The host processor (606) may execute the host calendar application (602) from a storage medium (604) and provide notifications to the attendees directly.

Attendees may access the host calendar application (602) through any type of communication network (608) such as the Internet. Attendees may logon from any computer (610) or other client device (612, 614) connected to the network (608). When an attendee logs on, he or she may have an account which retains information about the attendee including any scheduled events associated with the attendee. From that account, the attendee may be able to schedule meetings and communicate with other attendees. The attendee may also set preferences such as what delivery method preference for reminders and other notifications (e.g., text message to a cell-phone (612), automated call, email, or calendar application reminder).

In certain embodiments, the attendee may register his or her phone or mobile device (612) so that the attendee may receive notifications from the host calendar application (602) wherever they are, even when he or she is not logged on directly to the host calendar application web application or web service (602). The attendee may also register the GPS device (614) in his or her vehicle to interact with the host calendar application (602) (e.g., report the current location of the attendee to the host calendar application) while driving. In certain embodiments, the attendee may also receive a current location of other attendees on his or her GPS device (614) or other client device (610, 612).

In additional embodiments, the host calendar application (602) may be linked to alternative sources of information such as traffic or weather conditions which may affect the travel time of attendees to reach the event location. If the road conditions are bad, the host calendar application (602) may remind some or all of the attendees to leave earlier than they had originally planned. An attendee may also be able to tell the reminder system that he or she needs to make an additional stop on the way to the scheduled event location. In this case the reminder system will recalculate the route time and take that into account when notifying other attendees when to leave.

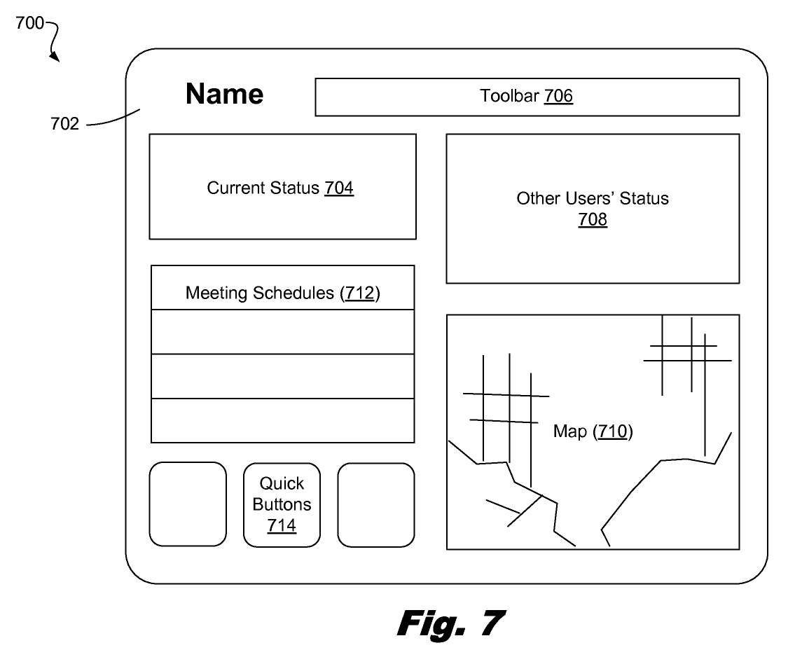

FIG. 7 is an illustration of an exemplary user interface (700) for a computerized calendar system consistent with the principles described herein. When an attendee logs on to a web application version of the reminder system or runs the local client software, he or she will interact with the computerized calendar system through some type of user interface. In the present example, the user interface (700) may include a display of the attendee's name (702) together with the attendee's settings or current status information (704). This information may include which devices the attendee has set up to be notified with or how much time before the user needs to leave should they be reminded. Additionally or alternatively, the interface (700) may display a list of scheduled events (712) associated with the attendee. In certain embodiments, the attendee may be able to add scheduled events and invite other users to confirm their attendance to those events. The user interface (700) may also include quick buttons (714) having a variety of purposes such as notifying other attendees that the user is leaving. The quick buttons may be set to any commonly used function that may suit a particular application of the principles described herein. A variety of additional settings and options may be available through menu commands organized in a toolbar (706). In certain embodiments, a window (708) displaying the status of other users may be included in the user interface (700) to let the attendee know of the status of other attendees, such as where they are currently located and whether or not they have left for a scheduled event. Additionally or alternatively, the user interface (700) may include a map (710) that displays the location of the current attendee and/or that of other attendees of a particular scheduled event. The map (710) may also show the routes each attendee will take to arrive at a scheduled event.

The user interface just described is merely one example of a user interface and in no way limits embodiments of principles described herein to the specific user interface (700). Any interface providing basic or advanced functionality may be used.

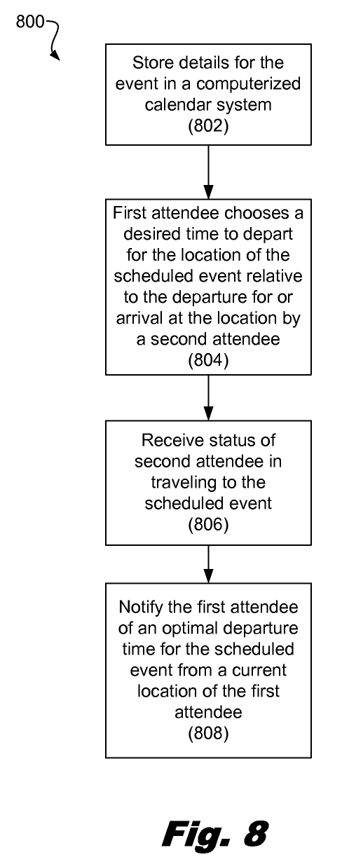

FIG. 8 is a flowchart (800) depicting an illustrative method of orchestrating the arrival of multiple attendees to a scheduled event. The method (800) includes first storing (step 802) details for the event in a computerized calendar system. The scheduled event may include a location, time, and a list of attendees for the event. A first attendee may choose (step 804) a desired time to depart for the location of the scheduled event relative to the departure for or arrival at the location by a second attendee. In certain embodiments, the second attendee may be selected by the first attendee.

At some point, the computerized calendar system may receive a status (step 806) of the second attendee in traveling to the scheduled event. The received status may be an actual status obtained either manually or automatically from the second attendee, a status for the second attendee estimated by the computerized calendar system, or a combination of actual and estimated statuses. As discussed above, the status may include, but is not limited to, a determination of whether the second attendee has already departed, a departure time of the second attendee, a current location of the second attendee, an anticipated arrival time of the second attendee, and an arrival time of said second attendee. In certain embodiments, an automatic scheduled event reminder notification may request or require a meeting attendee to provide his or her status (e.g., time of departure), as discussed above.

The computerized calendar system will notify (step 808) the first attendee of an optimal departure time for the scheduled event from a current location of the first attendee, where the optimal departure time is calculated based on the status of the second attendee to enable the first attendee to depart for the location of the scheduled event at his or her desired time with respect to the arrival or departure of the second attendee. Examples of suitable notifications include, but are not limited to, an email, a text message to a mobile device associated with the first attendee, an automatic phone call to a number associated with the first attendee, and/or an onscreen notification on a computer of the first attendee. In certain embodiments, the notification may be made substantially at the optimal departure time. Additionally or alternatively, the notification may be made prior to the optimal departure time as a reminder.

The computerized calendar system may be configured to calculate a route from the current location of the first attendee to the location of the scheduled event, calculate an estimated travel time for the first attendee to arrive at the scheduled event location via the calculated route, and calculate the optimal departure time using the estimated travel time. In certain embodiments, the route may be calculated taking into account traffic and weather conditions along various potential alternate routes and selecting the route with the least degree of traffic delays and/or the most favorable weather or road conditions. The calculated route may further take into account at least one user preference received from the first attendee, such as a planned stop at a certain location between the first attendee's current location and the location of the scheduled event.

Additionally, the computerized calendar system may calculate an estimated time of arrival of the second attendee to the scheduled event based on a detected departure time of the second attendee and calculate an optimal departure time for the first attendee by subtracting the estimated travel time for the first attendee from the estimated time of arrival of the second attendee.

In certain embodiments, the computerized calendar system may additionally track a location of the second attendee as the second attendee travels to the location of the scheduled event and dynamically update the optimal departure time for the first attendee responsive to a change in the estimated time of arrival of the second attendee.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method of orchestrating attendee arrivals to an event comprising;
storing a record for said event with a computerized calendar system, and
notifying a first attendee, with said computerized calendar system, of an optimal departure time for said scheduled event from a current location of said first attendee in response to a status of a second attendee in traveling to said scheduled event;
in which said optimal departure time comprises at least one of: a specified time relative to a departure of said second attendee and a specified time relative to an anticipated arrival of said second attendee.

2. The method of claim 1, in which said second attendee is designated by said first attendee.

3. The method of claim 1, in which said status of said second attendee comprises a detected departure time of said second attendee for said scheduled event from a known location.

4. The method of claim 3, in which said optimal departure time comprises said detected departure time of said second attendee plus an offset selected by said first attendee.

5. The method of claim 3, further comprising:
calculating with said computerized calendar system a route from said current location of a first attendee to said location of said scheduled event;
calculating an estimated travel time for said first attendee from said current location of said first attendee to said location of said scheduled event via said calculated route; and
calculating said optimal departure time using said estimated travel time.

6. The method of claim 5, further comprising:
calculating, with said computerized calendar system, an estimated time of arrival of said second attendee to said scheduled event based on said detected departure time of said second attendee; and
calculating, with said computerized calendar system, said optimal departure time for said first attendee by subtracting said estimated travel time for said first attendee from said estimated time of arrival of said second attendee.

7. The method of claim 6, further comprising tracking a location of said second attendee as said second attendee travels to said location of said scheduled event and updating said optimal departure time for said first attendee responsive to a change in said estimated time of arrival of said second attendee.

8. The method of claim 3, in which storing details for said event with said computerized calendar system further comprises selectively configuring said computerized calendar system to request attendees of said scheduled event to record their respective departure times for said scheduled event.

9. The method of claim 1, in which notifying said first attendee of said optimal departure time for said scheduled event comprises at least one of: sending said first attendee an email, sending said first attendee a text message to a mobile device, automatically calling a phone number associated with said first attendee, and displaying an onscreen notification to said first attendee.

10. Them method of claim 1, further comprising notifying said first attendee of said optimal departure time for said scheduled event at least at said optimal departure time.

11. The method of claim 1, further comprising notifying said second attendee with said computerized calendar system of an optimal departure time for said second attendee that is earlier than said optimal departure time for said first attendee.

12. A computerized calendar system comprising:
at least one processor configured to execute scheduling software and communicatively couple to at least one client device;
in which said at least one processor is configured to:
maintain a record of a scheduled event, said record comprising at least a location and list of attendees of said scheduled event;
calculate an optimal departure time for a first attendee of said scheduled event from a current location of said first attendee in response to a determined status of a second attendee in traveling to said scheduled event, said optimal departure time comprises at least one of: a specified time relative to a departure of said second attendee and a specified time relative to an anticipated arrival of said second attendee; and
transmit a notification to a client device associated with said first attendee, said notification comprising said optimal departure time for said first attendee.

13. The system of claim 12, in which said second attendee is designated by said first attendee.

14. The system of claim 12, in which each of said client devices comprises at least one of: a networked computer system, a mobile device, and a Global Positioning System (GPS) device.

15. The system of claim 12, in which said status of said second attendee comprises a detected departure time of said second attendee for said scheduled event from a known location.

16. The system of claim 15, in which said at least one processor is further configured to:
calculate a route from said current location of said first attendee to said location of said scheduled event;
calculate an estimated travel time for said first attendee from said current location of said first attendee to said location of said scheduled event via said calculated route; and
calculate said optimal departure time using said estimated travel time.

17. The system of claim 16, in which said at least one processor is further configured to:
calculate, with said computerized calendar system, an estimated time of arrival of said second attendee to said scheduled event based on said detected departure time of said second attendee; and
calculating, with said computerized calendar system, said optimal departure time for said first attendee by subtracting said estimated travel time for said first attendee from said estimated time of arrival of said second attendee.

18. The system of claim 17, in which said at least one processor is further configured to track a location of said second attendee as said second attendee travels to said location of said scheduled meeting and updating said optimal departure time for said first attendee responsive to a change in said estimated time of arrival of said second attendee.

19. The system of claim 18, in which said at least one processor is configured to track said location of said second attendee by tracking a location of a portable client device associated with said second attendee and communicatively coupled to said at least one processor.

20. A computer program product for orchestrating attendee arrivals to an event, the computer program product comprising:
a computer readable storage medium having computer readable program code embodied therewith, the computer readable program code comprising:
computer readable program code configured to maintain a record of a scheduled event, said record comprising a time, location, and list of attendees of said scheduled event; and
computer readable program code configured to notify a first attendee of said scheduled event of an optimal departure time for said scheduled event from a current location of said first attendee in response to a determined status of a second attendee in traveling to said scheduled event, said optimal departure time being calculated to enable said first attendee to arrive at a location of said scheduled event substantially concurrent to an arrival of said second attendee to said location of said scheduled event.
